(19) United States
(12) Patent Application Publication
(10) Pub. No.: US 2010/0110346 A1
(43) Pub. Date: May 6, 2010

(54) Methods of polarizing transparent conductive oxides, electronic devices including polarized transparent conductive oxides, and methods of manufacturing the electronic devices

(76) Inventors: Jung-hyun Lee, Suwon-si (KR); Dong-joon Ma, Anyang-si (KR)

Correspondence Address: HARNESS, DICKEY & PIERCE, P.L.C., P.O. BOX 8910, RESTON, VA, 20195, US

(21) Appl. No.: 12/588,383

(22) Filed: Oct. 14, 2009

(30) Foreign Application Priority Data
Oct. 14, 2008 (KR) 10-2008-0100760

(51) Int. Cl. G02F 1/1347; G21G 1/10; G02F 1/13

(52) U.S. Cl. 349/96; 250/492.3; 349/187

(57) ABSTRACT

Provided are methods of polarizing a transparent conductive oxide (TCO), electronic devices including a polarized TCO, and methods of manufacturing the electronic devices. A transparent conductive oxide formed on a substrate is polarized by electron beam annealing the transparent conductive oxide until a polarization voltage is generated in the transparent conductive oxide. The transparent conductive oxide may be a ZnO film or AlZnO film, where A is a cation. The electron beam annealing may be performed at about room temperature for less than about 60 minutes.

### CROSS-REFERENCE TO RELATED APPLICATIONS

This application claims priority under 35 U.S.C. §119 to Korean Patent Application No. 10-2008-0100760, filed on Oct. 14, 2008, in the Korean Intellectual Property Office (KIPO), the entire contents of which is incorporated herein by reference.

### BACKGROUND

1. Field

Example embodiments relate to methods of polarizing transparent conductive oxides (TCOs), electronic devices including polarized TCOs, and methods of manufacturing electronic devices including a polarized TCO.

2. Description of the Related Art

One of the drive operations for displays using liquid crystal, for example, thin film transistor-liquid crystal displays (TFT-LCDs), may be driving the liquid crystal. To form an image in a display using liquid crystal, the liquid crystal is oriented so that image information may pass through the liquid crystal according to an input of the image information. The liquid crystal is oriented by applying a high voltage to the liquid crystal via two opposite electrode plates. The TFT-LCD may include a low power drive and an overdrive for the orientation of the liquid crystal.

Because mobile electronic devices such as mobile phones, global positioning systems (GPSs), or personal digital assistants (PDAs) are relatively small, it is difficult to include a low power drive and an overdrive. Because a mobile electronic device is driven at a low voltage, the use of a liquid crystal display for the mobile electronic device may be difficult unless a low power drive method for the mobile electronic device is used. An afterimage may be generated due to a slow reaction of the liquid crystal to an applied voltage.

The electrode plates having the liquid crystal between them and facing each other, for example transparent conductive oxide (TCO) electrodes, have a resistance which is appropriate for an electrode use. The resistance may be obtained by applying heat treatment to the TCO for one hour or more at 250° C. However, the requirement of a relatively long heat treatment may be one of factors that impacts mass production of liquid crystal products.

### SUMMARY

One or more example embodiments include methods of polarizing transparent conductive oxides (TCOs) that are capable of orienting liquid crystal at a low voltage, electronic devices including a polarized TCO, and methods of manufacturing the electronic devices. One or more example embodiments correspondingly include a method of polarizing a TCO which includes forming a TCO on a substrate and performing electron beam annealing to the TCO.

According to one or more example embodiments, a method of polarizing a transparent conductive oxide includes electron beam annealing the transparent conductive oxide. The transparent conductive oxide may be a ZnO film or ZnO:A film, where A is a cation. The electron beam annealing may be performed at about room temperature for less than about 60 minutes. A polarization voltage may be generated in less than all of the TCO.

According to one or more example embodiments, an electronic device includes a liquid crystal layer, a first electrode and a second electrode facing the first electrode, the first and second electrodes configured to drive the liquid crystal layer, and at least one of the first and second electrodes including a transparent conductive oxide that is polarized to generate a polarization voltage. The first electrode may be a pixel electrode connected to a thin film transistor and the second electrode may be a common electrode. The electronic device may further include a light source radiating light that passes through the first electrode and is incident on the liquid crystal layer.

Any one of the first and second electrodes may be entirely polarized and the other one may be polarized only in a portion of the thickness of the other electrode. Both of the first and second electrodes may be entirely polarized. The second electrode may be entirely polarized or may be partially polarized. The second electrode may be only partially polarized in a thickness of the second electrode. The first electrode may be a plurality of first electrodes and a plurality of thin film transistor may be one-to-one connected to each first electrode. The electronic device may be a TFT-LCD.

According to one or more example embodiments, a method of manufacturing an electronic device may include forming a liquid crystal layer, forming a first electrode including a TCO, forming a second electrode including a TCO so that the first and second electrodes face each other, the liquid crystal layer between and configured to be driven by the first and second electrodes, and generating a polarization voltage in at least one of the first and second electrodes. The first electrode may be a pixel electrode connected to a thin film transistor and the second electrode may be a common electrode. The polarization voltage may be generated by electron beam annealing. The electron beam annealing may be performed at about room temperature for less than about 60 minutes.

The polarization voltage may be generated in the entirety of the at least one of the first and second electrodes, in at least a portion of both the first and second electrodes or in the entirety of one of the first and second electrodes and in a portion of the other electrode. The transparent conductive oxide may be a ZnO film or ZnO:A film, where A is a cation.

### BRIEF DESCRIPTION OF THE DRAWINGS

Example embodiments will be more clearly understood from the following brief description taken in conjunction with the accompanying drawings. FIGS. 1-7 represent non-limiting, example embodiments as described herein.

FIG. 1 is a cross-sectional diagram illustrating a method of polarizing a transparent conductive oxide (TCO) according to an example embodiment;

FIG. 2 is a cross-sectional diagram illustrating an arrangement state of dipoles of a TCO before an electron beam anneal is applied;

FIG. 3 is a cross-sectional diagram illustrating an arrangement state of dipoles of a TCO after an electron beam anneal is applied;

FIG. 4 is a graph of resistance as a function of electron beam annealing time showing a change in the resistance of an AlZnO TCO film;

FIG. 5 is a graph of capacitance as a function of voltage showing the voltage-capacitance characteristic of an AlZnO TCO film, before and after an electron beam anneal is applied;

FIG. 6 is an X-ray diffraction analysis graph showing the crystallization and orientation of a TCO according to the electron beam energy of an electron beam anneal; and

FIG. 7 is a cross-sectional diagram showing a portion of an electronic device having a polarized TCO according to an example embodiment.

Note that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

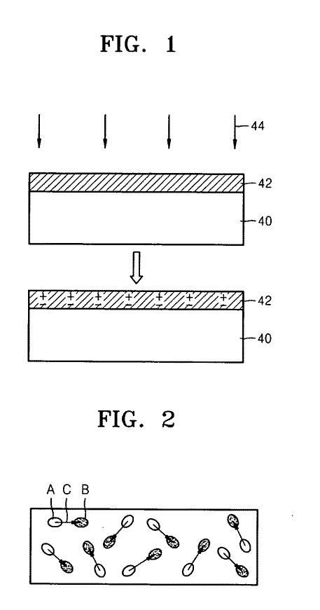

FIG. 1 is a cross-sectional diagram illustrating a method of polarizing a transparent conductive oxide (TCO) according to an example embodiment (hereinafter “polarization method”). Referring to FIG. 1, a TCO 42 may be on a substrate 40. The substrate 40 may be a silicon based substrate, for example, a p-type silicon wafer including a silicon oxide (e.g., SiO2). The silicon oxide may be on the p-type silicon wafer. The TCO 42 may be formed using any conventional method and may be in an amorphous state. The TCO 42 may be applied to liquid crystal displays or mobile devices. Any material that may be used as an electrode material driving liquid crystal may be used for the TCO 42. The TCO 42 may include cations coupled to oxygen, for example, a ZnO film or a ZnO:A film. In the ZnO:A film, “A” may be cations. The ZnO:A film may be, for example, an AlZnO film.

The TCO 42 may be exposed to an electron beam 44 having energy for a time to anneal the TCO 42. The anneal using the electron beam 44 may be performed at room temperature and at a pressure lower than atmospheric pressure (e.g., about 0.001-0.01 torr). When the energy of an electron of the electron beam 44 is E1, E1 may be, for example, about 0 eV<E1≦5 keV. When the exposure time of the electron beam 44 is t1, t1 may be, for example, about 0<t1<60 min. When the energy of the electron beam 44 is large or the amount of irradiation of electrons per unit area increases, the irradiation time of the electron beam 44 may be reduced. Although the energy of an electron of the electron beam 44 and the exposure time of the electron beam 44 may be maintained constant in a given scope, they may be different according to the type the TCO 42.

The electron beam 44 may be obtained by applying a voltage that is greater than about 0 kV and not more than about 5 kV to a grid of an electron beam generator (not shown). The electron beam generator may be a common generator or may be arranged to radiate the electron beam 44 at an angle, for example, using an inclined irradiation method. The electron beam generator may have a separate structure for radiating the electron beam 44. The electron beam generator may be configured as a square type linear gun that may radiate an electron beam over a large area, for example, an LCD panel.

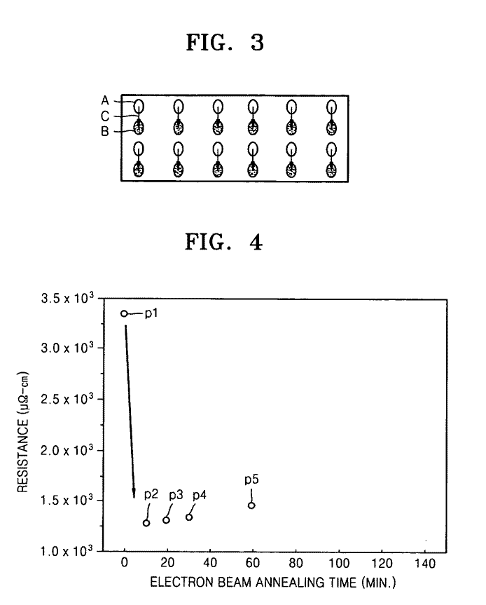

FIGS. 2 and 3 illustrate the arrangement state of dipoles of a TCO 42 before and after electron beam annealing. FIGS. 2 and 3 may illustrate the orientation of ZnO dipoles of a TCO 42 including ZnO before and after being exposed to an electron beam 44. In FIGS. 2 and 3, “A”, “B”, and “C” may respectively denote zinc (Zn), oxygen (0), and the polarization direction of a dipole formed of zinc and oxygen (hereinafter, “zinc-oxygen dipole”).

Referring to FIG. 2, the polarization direction C of the zinc-oxygen dipole may be non-directional (e.g., not set to a direction) before being exposed to the electron beam 44. Referring to FIG. 3, after the TCO 42 is exposed to the electron beam 44, the zinc-oxygen dipoles may be directionally oriented, the polarization direction C of each of the zinc-oxygen dipoles may be the same and the TCO 42 as a whole may be in a polarized state. The upper surface of the TCO 42 may be a cathode while the lower surface of the TCO 42 may be an anode. The entire thickness of a TCO 42 may be polarized or may partially be polarized.

FIG. 4 is a graph of resistance as a function of electron beam annealing time showing a change in the resistance of an AlZnO TCO film. Referring to FIG. 4, when the TCO 42 is an AlZnO film, resistance of the TCO 42 may change after the TCO 42 is exposed to the electron beam 44. In FIG. 4, a first position p1 may denote resistance of a TCO 42 that is not exposed to the electron beam 44 and the other positions p2-p5 may denote resistance of a TCO 42 exposed to the electron beam 44 for different lengths of time. The result shown in FIG. 4 may be obtained by radiating an electron beam of about 400 eV onto an AlZnO film. Referring to FIG. 4, after a TCO 42 is exposed to the electron beam 44, the resistance of the TCO 42 may be reduced from a resistance when the TCO 42 is not exposed to the electron beam 44. As a result of FIG. 4, it may be seen that by annealing the TCO 42 using the electron beam 44, the resistance of the TCO 42 may be lowered and the TCO 42 may be used as an electrode.

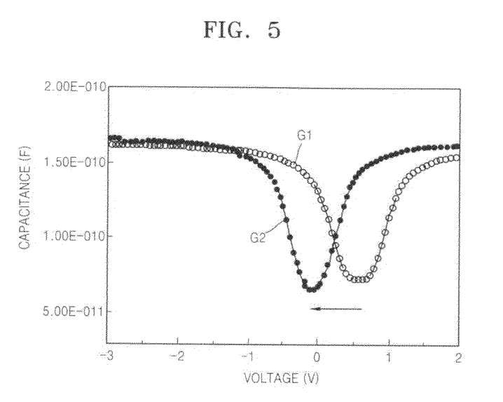

FIG. 5 is a graph of capacitance as a function of voltage showing the voltage-capacitance characteristic of an AlZnO TCO film, before and after an electron beam anneal is applied. FIG. 5 may show a capacitance measurement result as a function of voltage for a metal insulation semiconductor (MIS) structure in which a substrate, a silicon oxide, and the TCO 42 are sequentially deposited. An SiO2 film having about a 5 nm thickness may be used as the oxide and an AlZnO film may be used as the TCO 42. The substrate may be a P type silicon substrate.

Referring to FIG. 5, an electrically measured experimental result of a degree of orientation of the TCO 42 (e.g., the degree of orientation of the dipoles) may agree with the prediction that when the TCO 42 is exposed to the electron beam 44, so that the dipoles of the TCO 42 are directionally oriented, the capacitance curve may be shifted left by as great a magnitude as the polarization voltage of the TCO 42. The horizontal axis may indicate a voltage while the vertical axis may indicate capacitance as a function of the voltage. A first graph G1 may show the capacitance of a TCO 42 that is not exposed to the electron beam 44. A second graph G2 may show the capacitance of a TCO 42 that is exposed to the electron beam 44.

Comparing the first and second graphs G1 and G2 of FIG. 5, the second graph G2 may be moved left from the first graph G1 by as great a magnitude as a polarization voltage. From this result, it may be seen that the polarization voltage is generated in the TCO 42 after the TCO 42 is annealed using the electron beam 44. The dipoles of the TCO 42 may be directionally oriented after an electron beam anneal 44.

The result of FIG. 5 may show that the entire thickness of the TCO 42 may be polarized or may partially be polarized. The major reason for the shift of the second graph G2 of FIG. 5 may be a result of the annealing of the TCO 42 using the electron beam 44. If the annealing conditions of the electron beam 44 radiated onto the TCO 42 are changed, a degree of the shift of the second graph G2 may be adjusted. For example, by adjusting the irradiation energy, time, temperature, and distance of the electron beam 44, the second graph G2 may be shifted less than that shown in FIG. 5. The meaning of a shift of the second graph G2 that is less than that of FIG. 5 may signify that all dipoles of the TCO 42 may not be oriented in the same direction and that only the dipoles included in less than the entire of the TCO 42 are oriented in the same direction (e.g., less than the entire thickness). The polarization voltage may be generated in only a portion of the thickness of the TCO 42 and not in the overall thickness thereof.

In FIG. 5, although the shift of the second graph G2 may be affected by the temperature of the substrate 40 during the anneal, the thickness of the silicon oxide formed on the substrate 40, and/or the annealing atmosphere, the affect is negligible compared to the affect of the electron beam 44.

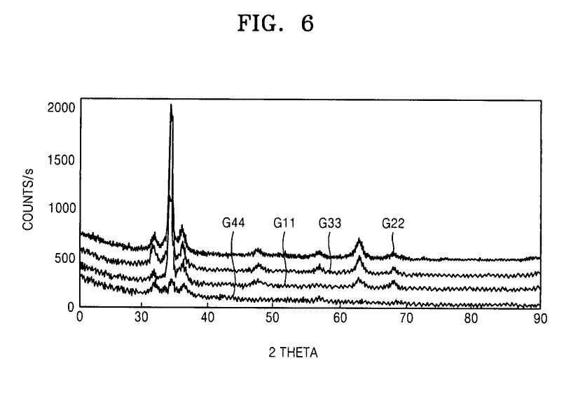

FIG. 6 is a graph for explaining an X-ray diffraction analysis that may show a change in the crystallization and orientation of a TCO 42 according to the exposure of the TCO 42 to an electron beam 44. In FIG. 6, first to fourth graphs G11, G22, G33, and G44 may show X-ray diffraction analysis results with respect to the TCO 42 when an electron beam 44, generated at voltages of about 400 V, 600 V, 800V, and 1000 V applied to the grid of an electron beam generator, irradiates a TCO 42. FIG. 6 shows an X-ray diffraction analysis of the TCO 42 when the energy of the electron beam 44 radiated onto a TCO 42 is increased. To obtain the result of FIG. 6, an AlZnO film may be used as the TCO 42 and the electron beam 44 may be radiated onto the TCO 42 at room temperature.

Referring to the fourth graph G44 of FIG. 6, when the energy of the electron beam 44 radiated onto the TCO 42 is about 1000 eV, corresponding to a voltage applied to the grid of the electron beam generator of about 1000 V, the crystallization of the TCO 42 may disappear and a degree of orientation may be deteriorated. When the energy of the electron beam 44 is lower than about 1000 eV, the TCO 42 may be crystallized and may have a high degree of orientation. The TCO 42 may be crystallized at about room temperature by the irradiation of the electron beam 44, when the energy of the electron beam 44 radiated onto TCO 42 is lower than that of the electron beam 44 that destroys or decreases the crystallization of the TCO 42.

Referring to FIG. 4, because an appropriate radiation time of an electron beam 44 may be less than about 60 minutes, the time needed to crystallize the TCO 42 may be less than about 60 minutes at about room temperature. Accordingly, according to example embodiments, the time needed to form a TCO may be reduced to less than an hour (e.g., less than 40 minutes). The manufacturing time of a product using the TCO as one of constituent elements (e.g., a liquid crystal display (LCD)), may be reduced so that manufacturing productivity may be improved.

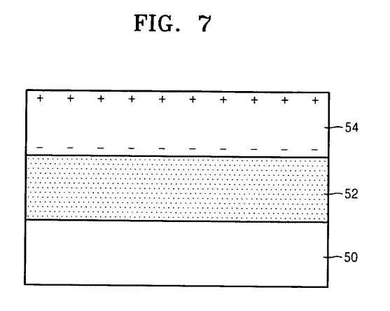

An electronic device including a TCO in which a portion or the entirety thereof may be polarized (hereinafter, “electronic device”) will now be described with reference to FIG. 7. FIG. 7 is a cross-sectional diagram showing a portion of an electronic device having a polarized TCO according to an example embodiment. Referring to FIG. 7, the electronic device may include a first electrode 50, a second electrode 54 and a liquid crystal layer 52 interposed between the first and second electrodes 50 and 54. The electronic device may be an LCD. The LCD may be a display having a large screen for home use and/or portable use. A light source, for example a backlight, for radiating light to a selected one of the first and second electrodes 50 and 54, may be further provided at a position that may be remote from the selected electrode. The LCD may be a reflection type that uses externally incident light.

The liquid crystal of the liquid crystal layer 52 may be oriented due to a difference in electric potential between the first and second electrodes 50 and 54. The first electrode 50 may be a pixel electrode including a transparent conductive oxide and connected to a thin film transistor (TFT) (not shown). The second electrode 54 may be a common electrode including a transparent conductive oxide. The first electrode 50 may be a part of a lower plate (not shown) provided under the liquid crystal layer 52. The first electrode 50 may be a plurality of first electrodes 50 in the lower plate. The lower plate may include a plurality of TFTs so that the first electrodes 50 and the TFTs may have a one-to-one relationship. The roles of the first and second electrodes 50 and 54 may be reversed with respect to each other. At least one of the first and second electrodes 50 and 54 may be a transparent conductive oxide that is partially or entirely polarized by being exposed to an electron beam. For example, when the second electrode 54 is a common electrode, the second electrode 54 may be a polarized TCO.

In FIG. 7, when the second electrode 54 is a polarized TCO, a polarization voltage exists in the second electrode 54. The polarization voltage may be applied to the liquid crystal layer 52. The polarization voltage may be a part of a voltage applied to the liquid crystal of the liquid crystal layer 52 to directionally orient the liquid crystal. The existence of the polarization voltage may have the same effect as that obtained by applying, in advance, a part of an orientation voltage applied to orient liquid crystal. The orientation voltage of the liquid crystal of a liquid crystal layer 52 may be lower than when the polarization voltage does not exist. When the second electrode 54 is a polarized TCO, a voltage needed for driving the liquid crystal layer 52 may be reduced and the reaction of the liquid crystal may be fast and/or increased. When the polarization voltage exists, because the orientation of the liquid crystal of a liquid crystal layer 52 may be completed before a voltage applied to a liquid crystal layer 52 becomes the voltage needed to orient the liquid crystal when there is no polarization voltage, the reaction of the liquid crystal may be fast and/or increased. Accordingly, an afterimage may be reduced.

Because the second electrode 54 may be formed by including an irradiation of the electrode 54 using an electron beam, (e.g., as described above with reference to FIG. 1), the second electrode 54 may have the characteristics of the polarized TCO of FIG. 1. The first electrode 50 may also be a polarized TCO. In this case, the voltage needed to orient liquid crystal of the liquid crystal layer 52 may be further reduced so that the reaction speed of the liquid crystal may be increased. When both of the first and second electrodes 50 and 54 are polarized TCOs, the polarization direction of the first and second electrodes 50 and 54 may be the same. Although every feature of an electronic device including a polarized TCO is not described, other features may be conventional features.

A method of manufacturing the above-described electronic device will now be described with reference to FIG. 7. In the manufacturing process of the electronic device, when the first electrode 50 and/or the second electrode 54 are formed, either the first electrode 50 or the second electrode 54 may be formed by irradiating an electronic beam to the TCO as described in FIG. 1. The conditions for radiation of the electron beam may be the same as that described with reference to FIG. 1. When the first electrode 50 is a pixel electrode connected to a TFT, the electron beam may be radiated onto the first electrode 50 before the first electrode 50 is patterned into a pixel electrode. When the first and second electrodes 50 and 54 are formed, by adjusting the conditions of the radiated electron beam, the polarization voltage may be generated only in a portion of the thickness of any of the first and second electrodes 50 and 54. The electronic device may be a TFT-LCD. Manufacturing methods of the electronic device that are not described herein may be, for example, conventional manufacturing processes.

It should be understood that the example embodiments described herein should be considered in a descriptive sense only and not for purposes of limitation. Descriptions of features or aspects within each embodiment should typically be considered as available for other similar features or aspects in other embodiments. While example embodiments have been particularly shown and described, it will be understood by one of ordinary skill in the art that variations in form and detail may be made therein without departing from the spirit and scope of the claims. For example, instead of sequentially depositing a silicon substrate and a silicon oxide to form a substrate 40 of FIG. 1, a silicon substrate and other oxide or a non-oxide insulation film may be sequentially deposited. As another example, the above-described polarized TCO may be applied to a non-display field or to an LCD other than a TFT-LCD.

What is claimed is:

1. A method of polarizing a transparent conductive oxide, the method comprising electron beam annealing the transparent conductive oxide.

2. The method of claim 1, wherein the transparent conductive oxide is a ZnO film or ZnO:A film, where A is a cation.

3. The method of claim 1, wherein the electron beam annealing is performed at about room temperature for less than about 60 minutes.

4. The method of claim 1, wherein the electron beam annealing is performed until a polarization voltage is generated in less than all of the transparent conductive oxide.

5. An electronic device, comprising:
a liquid crystal layer;
a first electrode; and
a second electrode facing the first electrode, the liquid crystal layer between the first and second electrodes, the first and second electrodes configured to drive the liquid crystal layer, and at least one of the first and second electrodes including a transparent conductive oxide that is polarized to generate a polarization voltage.

6. The electronic device of claim 5, wherein the first electrode is a pixel electrode connected to a thin film transistor, and
the second electrode is a common electrode.

7. The electronic device of claim 6, further comprising:
a light source radiating light, the light passing through the first electrode and incident on the liquid crystal layer.

8. The electronic device of claim 5, wherein the transparent conductive oxide is a ZnO film or ZnO:A film, where A is a cation.

9. The electronic device of claim 5, wherein one of the first and second electrodes is entirely polarized, and
less than all of one of the first and second electrodes is polarized.

10. The electronic device of claim 5, wherein both of the first and second electrodes are entirely polarized.

11. The electronic device of claim 5, wherein the second electrode is at least partially polarized.

12. The electronic device of claim 6, wherein the first electrode is a plurality of first electrodes, and
a plurality of thin film transistors are connected in a one-to-one relationship with the plurality of first electrodes.

13. A TFT-LCD, comprising the electronic device of claim 5.

14. A method of manufacturing an electronic device, the method comprising:
forming a liquid crystal layer;
forming a first electrode including a transparent conductive oxide (TCO);
forming a second electrode including a TCO so that the first and second electrodes face each other, the liquid crystal layer between and configured to be driven by the first and second electrodes; and
generating a polarization voltage in at least one of the first and second electrodes.

15. The method of claim 14, wherein the first electrode is a pixel electrode connected to a thin film transistor and the second electrode is a common electrode.

16. The method of claim 14, wherein the polarization voltage is generated by electron beam annealing.

17. The method of claim 16, wherein the electron beam annealing is performed at about room temperature for less than about 60 minutes.

18. The method of claim 14, wherein the polarization voltage is generated in the entirety of the at least one of the first and second electrodes.

19. The method of claim 14, wherein the polarization voltage is generated in at least a portion of both the first and second electrodes.

20. The method of claim 14, wherein the polarization voltage is generated in the entirety of one of the first and second electrodes, and
the polarization voltage is generated in only a portion of the other electrode.

21. The method of claim 14, wherein the transparent conductive oxide is a ZnO film or ZnO:A film, where A is a cation.
